(19) United States
(12) Patent Application Publication
(10) Pub. No.: US 2006/0065353 A1
(43) Pub. Date: Mar. 30, 2006

(54) Method of making articles of protective clothing containing adsorptive membranes

(76) Inventor: Cole Williams, Bainbridge Island, WA (US)

Correspondence Address: JAMES E. BRUNTON, ESQ., P. O. BOX 29000, GLENDALE, CA, 91209, US

(21) Appl. No.: 10/949,896

(22) Filed: Sep. 24, 2004

(51) Int. Cl. B29D 31/00

(52) U.S. Cl. 156/212; 156/214; 156/307.5

(57) ABSTRACT

A protective article such as a glove, sock or vest and the method of making same that is easy to don, is comfortable to wear and, at the same time, due to the incorporation of a novel membrane within which the highly adsorptive super-activated carbon particles are embedded, provides substantial protection to the user against exposure from hazardous chemical vapors. A unique feature of the method of the invention for making the protective articles of the invention is the novel step of incorporating highly adsorptive super-activated carbon particles within a thin polyurethane membrane in a manner such that the adsorptive properties of the activated carbon particles remain substantially undiminished.

### BACKGROUND OF THE INVENTION

1. Field of the Invention

The present invention relates generally to a method of making articles of protective clothing. More particularly, the invention concerns a method of making articles of protective clothing that include a thin polyurethane membrane within which a multiplicity of super-activated carbon particles have been embedded to form a highly adsorptive membrane.

2. Discussion of the Prior Art

Various attempts have been made in the past to produce articles of apparel such as gloves and socks that will protect the wearer from hazardous chemicals, chemical vapors and other toxins disposed within the environment to which the wearer is exposed. For example, U.S. Pat. No. 5,415,047 issued to Leach discloses sorbent, internally ribbed carbon-containing material and protective garments fabricated therefrom. The Leach material comprises at least one layer of an activated woven carbon fabric plus a high absorbency rayon layer interposed between at least one woven carbon fabric layer and the wearer's body. Similarly, U.S. Pat. No. 3,769,144 issued to Economy discloses a quilted fabric suitable for making protective garments that contain high surface area carbon fibers. The Economy quilted fabrics are made by uniting a central layer of flexible activated carbon fibers between a pair of outer layers of reinforcing fabric positioned on each side of the layer of activated flexible carbon fibers with a network of quilting stitching.

While the prior art materials that have been used in the construction of protective garments are generally satisfactory for sorbing toxic chemical vapors and the like, the garments constructed from the carbon containing material typically exhibit limited stretchability thereby making them less than ideally suited for construction of footwear and gloves. In addition, such prior art garments often tend to be bulky and uncomfortable.

The problems discussed in the preceding paragraph were earlier addressed by the present inventor and resulted in the development of novel protective garments, the character of which are disclosed in U.S. Pat. No. 6,662,377 issued on Dec. 16, 2003. The protective garments discussed in U.S. Pat. No. 6,662,377, which uniquely include an elastomeric polyurethane film to which a multiplicity of activated carbon micro-spheres are affixed, exhibit comfort and stretchability and, at the same time, are effective in protecting the wearer from hazardous materials such as chemical vapors, noxious gases and the like.

The present invention represents a significant advance in the state of the art of making protective garments and provides a novel method of making protective garments, which uniquely include a membrane for covering a portion of a wearer's body within which highly adsorptive, super-activated carbon particles have been incorporated. In the past, numerous unsuccessful attempts have been made to produce such a membrane. Such attempts have included mixing the carbon particles into a hydrocarbon solvent solution of a polyurethane resin and then casting or coating the mixture against a release paper. The coating is then dried to remove the solvent therefrom and to thereby form a thin membrane. However, in accordance with such prior art methods, the activated carbon undesirably retains some of the hydrocarbon solvent thereby substantially reducing the adsorptive properties of the activated carbon. It is this latter problem that the method of the present invention seeks to overcome in order to produce a membrane having superior adsorptive properties and one that can be incorporated into comfortable protective garments.

### SUMMARY OF THE INVENTION

It is an object of the present invention to provide protective garments, such as gloves and socks and the method of making the same that uniquely incorporate a thin membrane within which highly adsorptive, super-activated carbon particles are embedded. More particularly, it is an object of the invention to provide such protective garments, which are comfortable to wear and at the same time provide a high degree of protection to the user against hazardous exposure to various chemical vapors, and agents including noxious gases.

Another object of the invention is to provide a novel method for incorporating highly adsorptive super-activated carbon particles within a thin membrane in a manner such that the adsorptive properties of the activated carbon particles remain substantially undiminished.

Another object of the invention is to provide a protective article such as a glove, sock or vest that is easy to don, is comfortable to wear, and, at the same time, due to the incorporation of the membrane within which the highly desirable super-activated carbon particles are embedded, provides substantial protection to the user against exposure from hazardous chemical vapors.

Another object of the invention is to provide a method of making protective garments of the character described in the preceding paragraphs that is simple and straight forward, does not require the use of complicated equipment such as sewing and seaming equipment, and can be performed by unskilled workmen with a minimum of training.

In one form of the invention, the articles of the invention comprise articles of apparel that are of three-ply construction with the inside and outside plies being knit and the intermediate ply being made from the novel membrane within which the super-activated carbon particles are embedded.

By way of summary, one form of the method of the present invention for making a protective garment comprises the steps of wetting the activated carbon particles with liquid to provide a multiplicity of wetted particles; intermixing a polyurethane resin with a solvent to form a resin solution; intermixing the wetted particles with the resin solution to form a mixture; depositing the resultant mixture onto a surface; drying the mixture to remove the solvent and the liquid therefrom to form a membrane; forming the membrane into an adsorbent cover having a receiving portion having the general shape of the portion of the wearer's body to be covered; and bonding a first fabric member to the membrane to form the protective garment.

### BRIEF DESCRIPTION OF THE DRAWINGS

FIG. 1 is a side-elevational view illustrating the method of making the footwear article of the invention and showing the components of the article in position over a foot-shaped planar mandrel.

FIG. 2 is an enlarged, cross-sectional view taken along lines 2-2 of FIG. 1.

FIG. 3 is a side-elevational view of one form of the footwear article of the invention.

FIG. 4 is an enlarged, cross-sectional view taken along lines 4-4 of FIG. 3.

FIG. 5 is a fragmentary, cross-sectional view of the area designated as “5” in FIG. 4.

FIG. 6 is a top plan view showing the stretchable bladder component of the protective glove article of the invention in position over the glove mandrel.

FIG. 7 is a top plan view similar to FIG. 6, but showing the outer covering component of the glove in position over the inner liner, the bladder, and the mandrel.

FIG. 8 is an enlarged, cross-sectional view taken along lines 8-8 of FIG. 7.

FIG. 9 is an enlarged, fragmentary, cross-sectional view of the area designated in FIG. 8 as “9”.

FIG. 10 is a generally perspective view of an alternate form of protective clothing of the invention.

FIG. 11 is a greatly enlarged view taken along lines 11--11 of FIG. 10.

FIG. 12 is a greatly enlarged view of the area designated as “12” in FIG. 11.

FIG. 13 is a generally perspective view, partly broken away to show internal construction, illustrating one form of the method of the invention for making an article of apparel.

### DESCRIPTION OF THE INVENTION

The term “fabric” as used herein means a sheet structure made from fibers, filaments or yarns. Non-limiting examples include woven or non-woven sheets made by weaving, knitting, felting, hydroentangling or meltblowing fibers, filaments or yarns.

The term “sock” as used herein means a short, close fitting covering for the foot and lower leg constructed from any suitable material such as natural and synthetic fibers.

The term “glove” as used herein means a covering for the hand and wrist constructed from any suitable material such as natural and synthetic fibers.

The term “vest” as used herein means a covering for the trunk of the user.

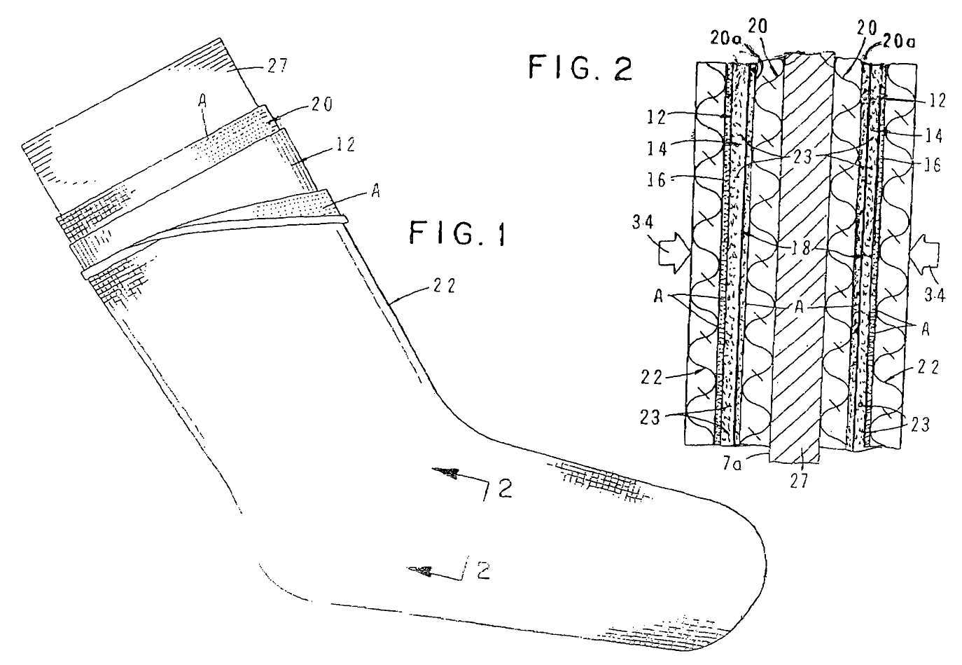

Referring to the drawings and particularly to FIGS. 1 through 5, one form of the protective garment of the present invention is there shown. The garment here comprises a sock construction including a thin adsorbent cover 12 formed from a pliable membrane the unique character of which will presently be described. Adsorbent cover 12 includes a foot portion 14 having an outer surface 16 and an inner surface 18 (FIG. 2). Adsorbent cover 12 has the capability of generally conforming to the contours of the human foot so that it can be comfortably worn inside a boot or shoe. Bonded to the inner surface 18 of the cover is a lightweight covering member such as a fabric inner sock 20 of standard construction, which is preferably made from knitted natural or synthetic fibers. The footwear article of the invention shown in FIG. 1 also includes an outer sock 22, which is disposed proximate the outer surface of adsorbent cover 12. Outer sock 22 can also be constructed from filament or spun yarns. The sock can also be constructed from natural fibers such as wool fibers, or from a variety of synthetic fibers such as polyester, nylon and combinations thereof.

Before discussing the details of the method of making the sock of the invention, the method of making the novel membrane used to construct the adsorbent cover component 12 of the sock will be considered. In one form of the method of the invention the membrane is constructed from a polyurethane resin within which super-activated carbon in the form of a granular powder is embedded. While such material is available from various sources, a material sold by Kansai Coke & Chemicals Company of Ohama-cho, Amagasaki-shi, Japan has proven to be well suited for use in making the adsorptive membrane of the present invention. This activated carbon exhibits a surface area of 3350 m² per gram with the median size of the particles of carbon being on the order of 78 microns. It is apparent that with this very large surface area, each granule of the material has millions of tiny gas adsorbing pores.

In making the membrane in accordance with one form of the method of the invention, a hydrocarbon solvent is first intermixed with a polyurethane resin to form a resin solution. Next, the granules of activated carbon are intermixed with the resin solution to form a carbon polyurethane resin mixture. However, to prevent the undesirable dilution of the adsorptive qualities of the activated carbon by the hydrocarbon solvent solution clogging the pores of the material during the step of intermixing the activated carbon particles with the resin solution, the method of the present invention uniquely involves the step of thoroughly wetting the super-activated carbon with water prior to intermixing it with the polyurethane resin hydrocarbon solvent mixture. This novel step causes the millions of tiny pores of the activated carbon material to fill with water, thereby preventing the hydrocarbon solvent from filling the pores of the activated carbon during the intermixing of the wetted activated carbon with the polyurethane resin mixture.

In accordance with one form of the method of the invention, after intermixing the wetted activated carbon with the polyurethane resin solution, the mixture thus formed is controllably heated to drive off both the solvent and the water so as to once again open the pores in the activated carbon material to thereby substantially restore its adsorbing characteristics.

By way of example, in carrying out one form of the method of the present invention, the Kansai Coke & Chemicals Company super-activated carbon granules 23 are first thoroughly wetted with water to provide a multiplicity of wetted particles. Next, a readily commercially available polyurethane resin, such as that available from the Dow Chemical Co. of Midland, Mich. is intermixed with a suitable hydrocarbon solvent to form a resin solution. This done, the wetted particles are intermixed with the resin solution to form a carbon polyurethane resin mixture and the resin mixture thus formed is deposited onto a generally flexible substrate, such as a sheet of paper or the like having a substantially planar surface to form a thin mass. The thin mass is then heated by any suitable means to an elevated temperature sufficient to remove therefrom the hydrocarbon solvent and the water to form the adsorptive membrane within which the super-activated carbon granules 23 are embedded.

In accordance with the method of making the protective articles of clothing of the invention, the adsorptive membrane produced in the manner discussed in the preceding paragraphs is formed into the previously discussed adsorbent cover 12. This step can be accomplished in various ways, including the step of forming the membrane into a bladder like construction. This is accomplished by first overlaying two sheets of the membrane to form a membrane assemblage. Next, the membrane assembly is heated along a boundary line to a temperature sufficient to sealably bond the sheets together along the boundary line to form the adsorbent cover 12. One technique, which has proven to be satisfactory in forming the cover 12 in the manner thus described, involves the use of a heated platen press embodying a die having the general shape of the outer boundary line of the user's extremity to be covered. In accordance with this technique, with the two sheets of the membrane in position within the press, compressed air having a line pressure of about 120 to about 130 pounds per square inch is applied to the press. This done, the die is electrically heated to between about 500 and 600 degrees Fahrenheit for a period of about 5 to 20 seconds. This controlled heating of the dies causes the sheets of membrane material to be effectively welded, or sealably joined together along the boundary line to make the sock shaped cover. After the welding process, the excess material outside the cover boundary is manually stripped away and the assemblage is removed from the platen press.

In continuing with the method of making the protective footwear article of the invention, the inner sock 20 is placed over mandrel 27 in the manner illustrated in FIG. 1 of the drawings and is smoothed out so that its inner surface is in close engagement with the faces of the mandrel 27. This done, the sock-shaped, bladder, or adsorbent cover 12, which has been adhesive coated with particles of hot melt adhesive inside and outside is carefully placed over the assemblage of inner sock 20 and mandrel 27. A hot melt adhesive in powder form sold by Bostik, Middleton, Mass., product #5116, a polyester type, has proven satisfactory for this purpose. Other suitable adhesives can, of course, also be used, including an adhesive in liquid form, which can be sprayed, brushed or otherwise applied to the elastomeric bladder or to the sock fabric. Following the placement of the cover 12 over the inner sock 20, the outer sock 22 is placed over both the inner sock 20 and the cover 12 in the manner indicated in FIG. 1.

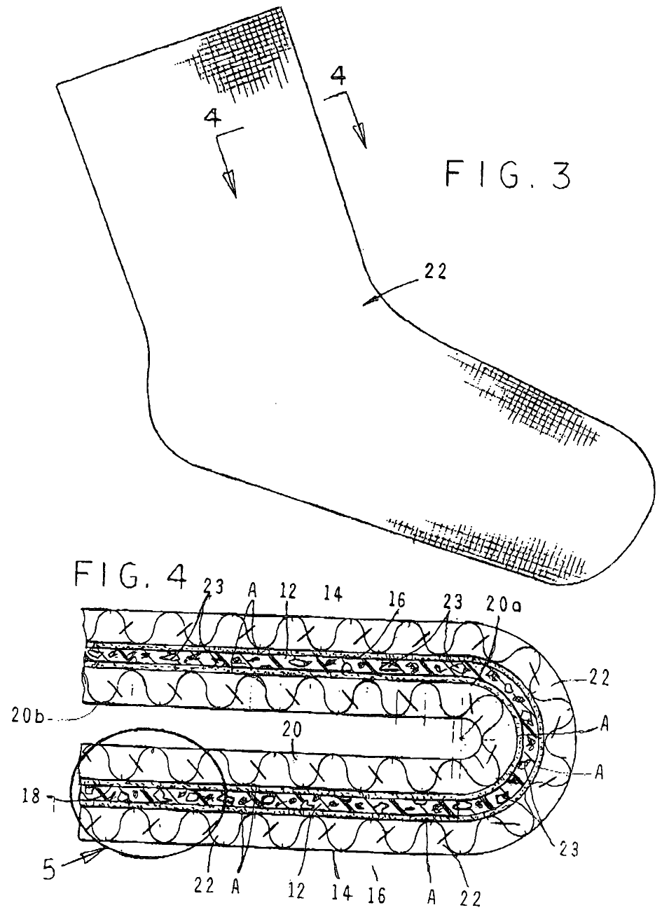

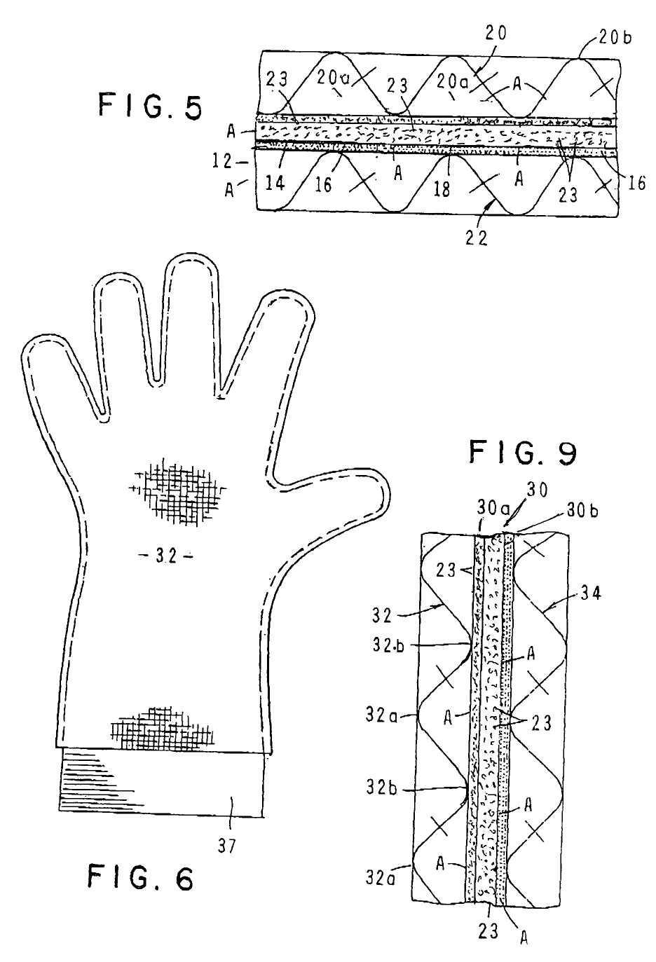

The precursor assembly comprising first inner sock 20, the adhesive coated adsorbent cover 12 and the second outer sock 22 is then heated and compressed in the direction of the arrows 34 in FIG. 2 to form the finished article. (See FIG. 3). This step is accomplished by placing the mandrel, upon which the precursor assembly is mounted, between two platens, which can be controllably heated and urged together. More particularly, the platens are preferably electrically heated to a temperature of between about 250 and 300 degrees Fahrenheit and are controllably moved into pressural engagement with the precursor assembly by any type of hydraulically actuated pressure imparting assembly of a character well known to those skilled in the art. A commercially available press suitable for carrying out the method of the invention is sold by PHI of the City of Industry, Calif. During this temperature-pressure step, the heat-activated adhesive is thereby fused making a permanent bond of inner sock 20 to one side of the adsorbent cover 12 and the outer sock 22 to the other side of the bladder. (See FIG. 4). The minimum temperature required to activate the Bostik #5116 adhesive is 268 degrees Fahrenheit. Accordingly, a temperature range of between about 270 degrees Fahrenheit and 290 degrees Fahrenheit is preferred. During this temperature-pressure step, portions 20a of the fabric of the inner sock is urged into the irregularities in the surface of the cover 12 in the manner shown in FIG. 5 and into engagement with the adhesive “A” for secure bonding.

The precursor assembly is then removed from the press and allowed to cool thoroughly prior to doffing the completed footwear article or garment from the mandrel.

When removed from the mandrel, the footwear article is generally planar in shape. However, upon inserting the foot into the open cuff of the article, the foot-engaging portion of the sock will neatly and smoothly conform to the shape of the wearer's foot.

For certain applications, the footwear article of the invention can be constructed by bonding to the adsorbent cover 12 only a single inner or outer sock. This two, rather than three-ply construction, can be used in a number of applications in which the three or more ply constructions are not necessary.

Turning now to FIGS. 6 through 9 of the drawings, another form of protective garment of the invention can be seen to comprise a glove construction that includes a thin, pliant membrane constructed in the manner previously described herein. As before, the membrane is formed into an adsorbent cover, which is generally designated in FIGS. 6 through 9 by the numeral 30. Cover 30 can be formed in various ways, including forming the membrane into a generally hand shaped bladder in a similar manner to the method used to form the bladder incorporated into the sock construction of the invention. Bonded to the inner surface 30a of the cover 30 is a lightweight covering member such as a fabric inner glove 32 of standard construction, which is preferably made from knitted natural or synthetic fibers.

The protective glove garment of the invention also includes an outer glove 34, which is disposed proximate the outer surface 30b of cover 30. Outer glove 34 can also be constructed from filament or spun yarns. The glove 34 can also be constructed from natural fibers; such as wool fibers or from a variety of synthetic fibers such as polyester nylon and combinations thereof.

Inner glove 32 is preferably bonded to adsorbent cover 30 by means of a selected one of the previously described waterproof, heat activated adhesives. Similarly, glove 34 is bonded to bladder 30 by means of a similar heat activated adhesive “A”.

For certain applications the glove of the invention can be constructed by bonding to the cover 30 only a single inner or outer glove. This two, rather than three-ply construction, can be used in a number of applications in which the three or more ply constructions are not necessary.

Considering now in greater detail the method of the invention for making the protective glove garment, this method is similar in many respects to the method described for making the sock garment and makes use of a novel membrane within which a multiplicity of super-activated carbon particles 23 have been embodied. This unique membrane is constructed in accordance with the novel method previously described herein in a manner such that the adsorptive properties of the activated carbon particles that are embedded within the membrane remain substantially undiminished.

After the membrane has been produced and the surfaces thereof coated with an appropriate outer adhesive, the next step in this latest method of the invention is the construction of the adsorbent cover component 30. While the cover component can be constructed in various ways, forming the membrane into a bladder like construction has proven quite satisfactory. As before, this step is accomplished by overlaying two sheets of the membrane material and then heating the assemblage thus formed along the boundary line to a temperature sufficient to sealably bond the sheets together along the boundary line to form a generally hand shaped bladder. As before, this bonding step involves the use of a heated platen press similar to that previously described which embodies a die having the shape of an outer boundary line that generally corresponds to the shape of the hand. In this connection, with the membrane sheets in position within the press, compressed air at a pressure of about 120 to about 130 pounds per square inch is exerted on the press and the die is electrically heated to between about 500 and about 600 degrees Fahrenheit for a period of about 5 to 20 seconds. This controlled heating of the dies causes the membrane sheets to be effectively welded, or sealably joined together along the boundary line to make the glove-shaped substrate. After the welding process has been completed, the excess material outside the bladder boundary is manually stripped away and the assemblage is removed from the platen press.

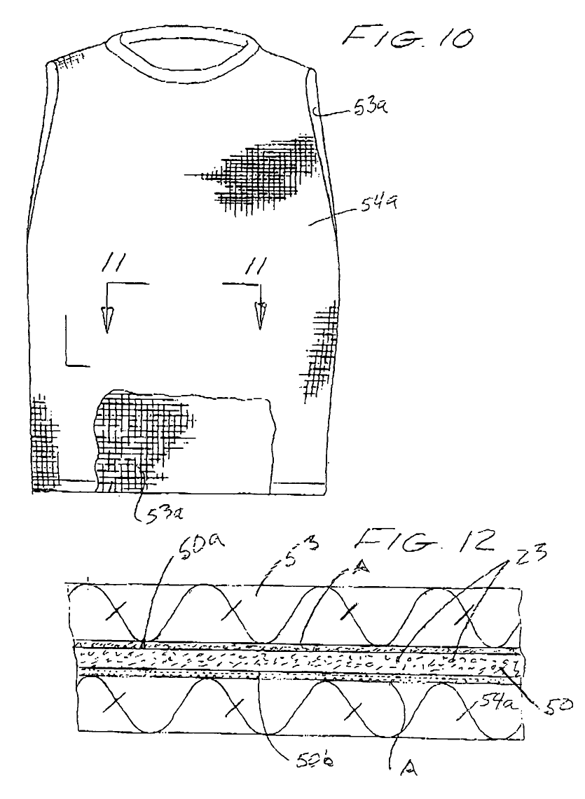

The next step in the method of the invention is to place the first covering member, or inner glove 32, over a generally hand-shaped, approximately 1/16th inch thick, generally planar mandrel 37 (see FIG. 6). Inner glove 32, which has inner and outer surfaces 32a and 32b (FIG. 8) is placed over the mandrel so that inner surface 32a thereof is disposed in engagement with the faces 37a of mandrel 37. Inner glove 32 can be constructed from a variety of materials of the character previously described herein.

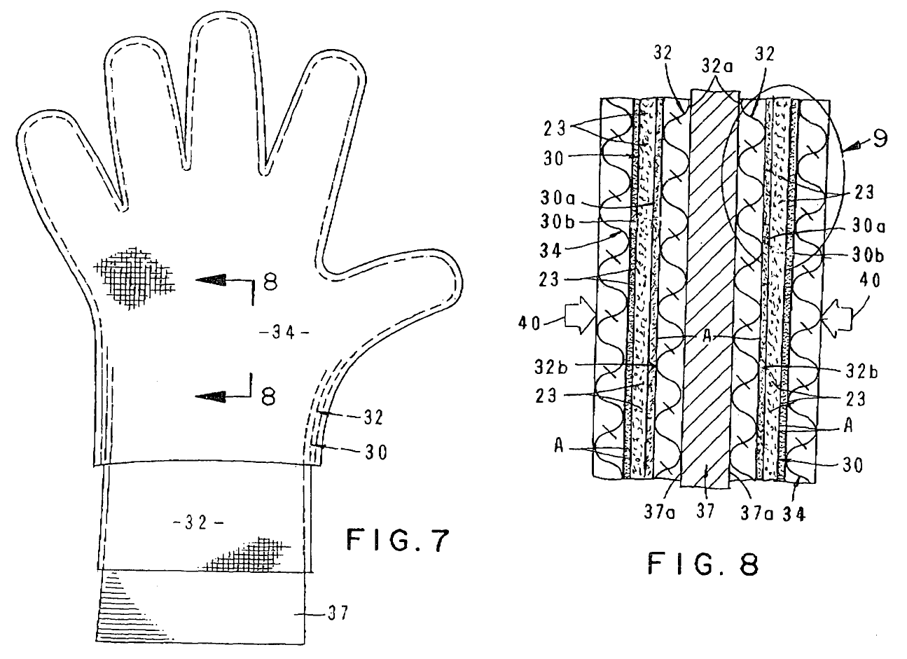

After inner glove 32 has been placed over mandrel 37 and smoothed out so that its inner surface 32a is in close engagement with the faces of the mandrel 37, cover 30 which has been adhesive coated with particles of hot melt adhesive inside and outside is carefully placed over the assemblage of inner glove 32 and mandrel 37. Outer glove 34 is then placed over both the inner glove 32, the adsorbent cover 30, and the mandrel 37 (FIG. 7).

The precursor assembly comprising first inner glove 32, cover 30 and the second outer glove 34 is then heated and compressed in the direction of the arrows 40 in FIG. 8 to form the finished article. This step is accomplished by placing the mandrel, upon which the precursor assembly is mounted, between two platens, which can be controllably heated and urged together. More particularly, the platens are preferably electrically heated to a temperature of between about 260 and 300 degrees Fahrenheit and are controllably moved into pressural engagement with the precursor assembly by any type of hydraulically actuated pressure imparting assembly of a character well known to those skilled in the art. A commercially available press suitable for carrying out the method of the invention is sold by PHI of the City of Industry, Calif. During this temperature-pressure step, the heat-activated adhesive is thereby fused making a permanent bond of inner glove 32 to one side of the bladder and the outer glove 34 to the other side of the bladder. The minimum temperature required to activate the Bostik #5116 adhesive is 268 degrees Fahrenheit. Accordingly, a temperature range of between about 270 degrees Fahrenheit and 290 degrees Fahrenheit is preferred.

The precursor assembly is then removed from the press and allowed to cool thoroughly prior to removing the protective glove garment. When removed from the mandrel, the protective glove is generally planar in shape. However, upon inserting the hand into the open cuff of the glove, the hand-engaging portion of the glove will neatly and smoothly conform to the shape of the wearer's hand.

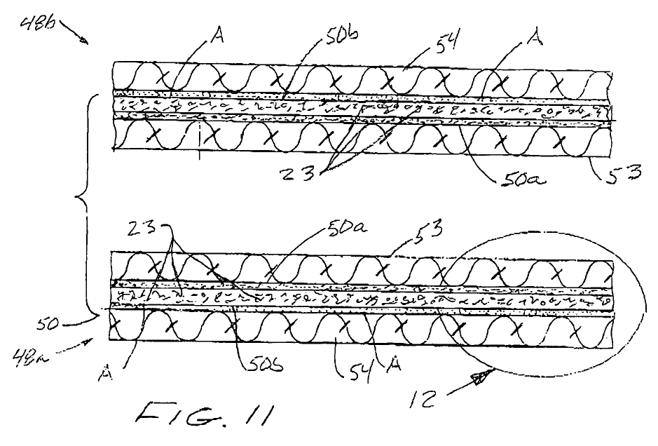

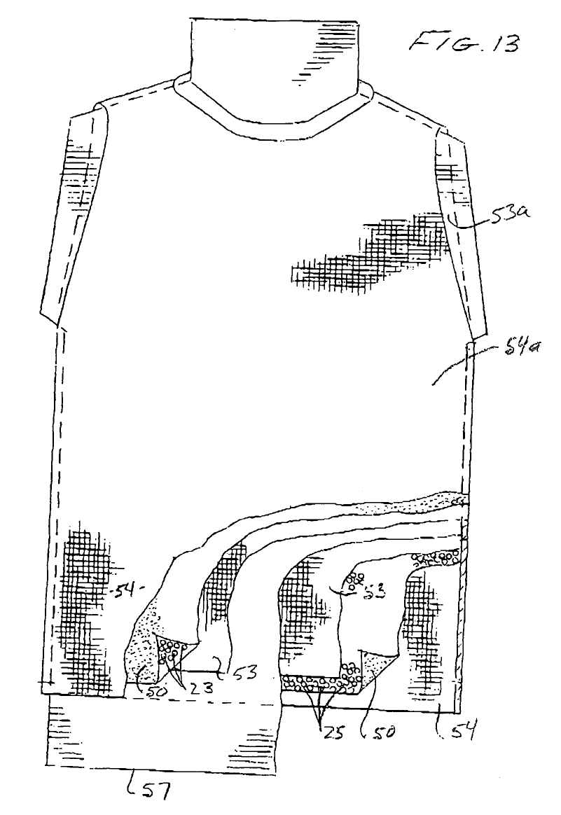

Turning next to FIGS. 10, 11, 12, and 13 of the drawings, still another form of protective garment of the invention is there shown. This garment is similar in some respects to those previously described herein and like numbers are used to identify like components. The garment here comprises a vest-like construction having interconnected front and back panels 48a and 48b respectively, each of which includes an adsorbent cover 50 constructed from a membrane of a character previously described within which a multiplicity of super-activated carbon particles 23 are embedded (FIG. 11). As before, the membrane is made in accordance with the method earlier described in a manner such that the adsorptive properties of the activated carbon particles that are embedded within the membrane remain substantially undiminished.

Bonded to the inner surface 50a of the adsorbent cover 50 is a lightweight member such as a fabric inner vest liner 53a, which comprises interconnected front and back panels 53. Vest liner 53 is of conventional construction, and is preferably made from knitted natural or synthetic fibers formed into a vest-shaped, generally tubular configuration (see FIG. 10).

Each of the front and back panels of the protective garment of this latest form of the invention also includes an outer covering 54a, which is disposed proximate the outer surface 50b of cover 50. Outer covering 54 can be constructed from filament or spun yarns of various types from natural fibers such as wool fibers and from a variety of synthetic fibers such as polyester nylon and combinations thereof. Outer covering 54a, which is generally tubular in shape comprises interconnected front and back panels 54 and has the generally vest-shaped configuration shown in FIG. 10.

The inner liner 53 of each of the front and back panels is preferably bonded to cover 50 by means of a selected one of the previously described waterproof, heat activated adhesives “A”. Similarly, outer covering 54 is bonded to cover 50 by means of a similar heat activated adhesive “A”.

For certain applications the article of this latest form of the invention can be constructed by bonding to cover 50 only a single inner or outer vest liner or cover component. This two, rather than three-ply construction, can be used in a number of applications in which the three or more ply constructions are not necessary.

Considering next the method of the invention for making the protective vest-like garment, this method is similar in many respects to the method described for making the sock and glove garments and makes use of the novel membrane material of the invention both surfaces of which have been coated with a suitable adhesive.

The initial step in this latest form of the method of the invention is the construction of the generally tubular shaped cover component for the vest article. This is accomplished by overlaying two sheets of the previously described membrane material and then heating the assemblage thus formed along a boundary line generally corresponding to the shape of the front and rear panels of the vest article to a temperature sufficient to sealably bond the sheets together along the boundary line to form a generally tubular shaped cover 50. In accordance with this technique, with the membrane assemblage in position within the press, compressed air having a line pressure of about 120 to about 130 pounds per square inch is applied to the press. This done, the die is electrically heated to between about 500 and 600 degrees Fahrenheit for a period of about 5 to 20 seconds. This controlled heating of the dies causes the sheets of membrane material to be effectively welded, or sealably joined together along the vest boundary line to make the vest shaped, bladder substrate or adsorbent cover 50. After the welding process, the excess material outside the bladder boundary is manually stripped away and the assemblage is removed from the platen press.

The next step in the method of the latest form of the invention is to place the first covering member or inner vest liner 53a over a generally vest-shaped, substantially planar aluminum mandrel 57. Inner vest liner 53a, which comprises the previously identified front and back panels 53, is placed over the mandrel so that inner surface thereof is disposed in engagement with the faces 57a of mandrel 57 (FIG. 13).

After inner vest liner 53a has been placed over mandrel 57 and smoothed out so that its inner surface is in close engagement with the faces of the mandrel 57, the generally vest-shaped adsorbent cover 50, which has been adhesive coated with particles of hot melt adhesive inside and outside is carefully placed over the assemblage of inner vest liner 53a and mandrel 57. Outer vest liner 54a is next placed over both the inner vest liner 53a and the adhesive coated cover 50.

The precursor assembly comprising first inner vest liner 53a, the adhesive-coated cover 50 and the second outer vest liner 54a is then heated and compressed to form the finished article. This step is accomplished by placing the mandrel, upon which the precursor assembly is mounted, between two platens that can be controllably heated and urged together. More particularly, in one form of the invention, the platens are electrically heated to a temperature of between about 260 and 300 degrees Fahrenheit and are controllably moved into pressural engagement with the precursor assembly by any type of hydraulically actuated pressure imparting assembly of a character well known to those skilled in the art. During this temperature-pressure step, the heat-activated adhesive is thereby fused making a permanent bond of inner vest liner 53a to one side of the adsorbent cover 50 and the outer vest liner 54a to the other side of the cover 50. When the previously identified Bostik #5116 adhesive is used, the minimum temperature required to activate the adhesive is 268 degrees Fahrenheit. Accordingly, a temperature range of between about 270 degrees Fahrenheit and 290 degrees Fahrenheit is preferred. During this temperature-pressure step portions of the fabric of the inner vest liner are urged into the irregularities in the surface of the adsorbent cover 50 and into engagement with the adhesive “A” for secure bonding.

The precursor assembly is then removed from the press and allowed to cool thoroughly prior to doffing the complete protective vest article or garment from the mandrel.

When removed from the mandrel, the protective vest is generally planar in shape. However, upon slipping the protective vest over the wearer's trunk, the garment will neatly and smoothly conform to the shape of the trunk portion of the user's body.

Having now described the invention in detail, in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A method of making a protective garment used to cover a portion of a wearer's body that incorporates a membrane containing activated carbon particles comprising the steps of:
(a) wetting the activated carbon particles with liquid to provide a multiplicity of wetted particles;
(b) intermixing a polyurethane resin with a solvent to form a resin solution;
(c) intermixing said wetted particles with said resin solution to form a mixture;
(d) depositing said mixture onto a surface; and
(e) drying said mixture to remove the solvent and the liquid therefrom to form a membrane;
(f) forming said membrane into an adsorbent cover having a receiving portion having the general shape of the portion of the wearer's body to be covered and including an outer surface and an inner surface generally conformable to the portion of the wearer's body to be covered; and
(c) bonding a first fabric member to said stretchable bladder to form a first assembly.

2. The method as defined in claim 1 in which said liquid comprises water.

3. The method as defined in claim 1 in which said mixture is heated to an elevated temperature sufficient to remove the hydrocarbon solvent and the liquid from said mixture.

4. The method as defined in claim 1 in which said surface comprises a sheet of paper.

5. A method as defined in claim 1, including the further step of bonding a second covering member to said first assembly to form a second assembly.

6. The method as defined in claim 5 including the further step of heating said second assembly.

7. The method as defined in claim 5 in which said first fabric member is bonded to said adsorbent cover using a heat-activated adhesive.

8. A method of making an article of protective clothing used to cover a portion of a wearer's body that incorporates a membrane containing activated carbon particles comprising the steps of:
(a) wetting the activated carbon particles with water to provide a multiplicity of wetted particles;
(b) intermixing a polyurethane resin with a hydrocarbon solvent to form a resin solution;
(c) intermixing said wetted particles with said resin solution to form a carbon polyurethane resin mixture;
(d) depositing said carbon polyurethane resin mixture onto a substrate having substantially planar surface to form a thin mass;
(e) drying said thin mass to remove the hydrocarbon solvent and the water therefrom to form an adsorptive membrane;
(f) forming said adsorptive membrane into an adsorbent cover having a receiving portion having the general shape of the portion of the wearer's body to be covered and including an outer surface and an inner surface generally conformable to the portion of the wearer's body to be covered;
(g) bonding a first fabric member to said adsorbent cover to form a first assembly; and
(h) heating said first assembly to an elevated temperature while exerting pressure on said first assembly.

9. The method as defined in claim 8 in which said mass is heated to an elevated temperature sufficient to remove the hydrocarbon solvent and the water from said carbon polyurethane resin mixture.

10. The method as defined in claim 8 in which said substrate comprises a sheet of generally flexible material.

11. A method as defined in claim 8, including the further step of bonding a second covering member to said first assembly to form a second assembly.

12. The method as defined in claim 8 in which said adsorbent cover has the general shape of a sock.

13. The method as defined in claim 8 in which said adsorbent cover has the general shape of a glove.

14. The method as defined in claim 8 in which said adsorbent cover has the general shape of a vest.

15. A method of making an article of protective clothing used to cover a portion of a wearer's body that incorporates a membrane containing activated carbon particles comprising the steps of:
(a) wetting the activated carbon particles with water to provide a multiplicity of wetted particles;
(b) intermixing a polyurethane resin with a hydrocarbon solvent to form a resin solution;
(c) intermixing said wetted particles with said resin solution to form a carbon polyurethane resin mixture;
(d) depositing said carbon polyurethane resin mixture onto a substrate having substantially planar surface to form a thin mass;
(e) heating said thin mass to an elevated temperature to remove the hydrocarbon solvent and the water therefrom to form an adsorptive membrane;
(f) forming said adsorptive membrane into a cover having a receiving portion having the general shape of the portion of the wearer's body to be covered and including an outer surface and an inner surface generally conformable to the portion of the wearer's body to be covered;
(g) using an adhesive, bonding a first fabric member to said cover to form a first assembly;
(h) using an adhesive, bonding a second fabric member to said first assembly to form a second assembly; and
(i) heating said second assembly to an elevated temperature while exerting pressure on said second assembly.

16. The method as defined in claim 14 in which said substrate comprises a sheet of generally flexible material.

17. The method as defined in claim 14 in which said cover has the general shape of a sock.

18. The method as defined in claim 14 in which said cover has the general shape of a glove.

19. The method as defined in claim 14 in which said cover has the general shape of a vest.

20. The method as defined in claim 14 in which said adhesive comprises a heat activated adhesive.
